(19) United States
(12) Patent Application Publication
(10) Pub. No.: US 2015/0340767 A1
(43) Pub. Date: Nov. 26, 2015

(54) A DUAL ANTENNA

(71) Applicant: THRANE & THRANE A/S, Kgs. Lyngby (DK)

(72) Inventors: Thomas SMITH, Copenhagen (DK); Johan GRANHOLM, Copenhagen (DK); Olav BREINBJERG, Copenhagen (DK); Oleksiy KIM, Rodovre (DK)

(21) Appl. No.: 14/759,886

(22) PCT Filed: Jan. 9, 2013
(86) PCT No.: PCT/EP2013/050259

§ 371 Date: Jul. 8, 2015

(51) Int. Cl. H01Q 19/19; H01Q 1/36

(52) U.S. Cl. CPC H01Q 19/193; H01Q 1/362; H01Q 19/191; H01Q 19/192

(57) ABSTRACT

A dual antenna comprising a dual reflector set-up with a main reflector, a sub-reflector and a feed antenna, where a helix is provided which also utilizes the main reflector. The sub-reflector is positioned between the main reflector and the helix so that the helix will not unnecessarily disturb the operation of the dual reflector set-up while using the main reflector.

The present invention relates to a dual antenna and in particular to a dual-reflector antenna comprising a backfire helix using the sub-reflector as its reflector.

In recent years, the internet has become the keystone in modern communication systems. Both land-based as well as many mobile users, e.g. maritime, demand easy, reliably and low-cost access to high-speed communications via the internet. For some applications, e.g. maritime, wireless data communications via e.g. satellite is the preferred method to provide the necessary bandwidth. As the data bandwidth requirements continue to grow, satellites therefore have to operate at yet higher frequencies, moving from e.g. nowadays typically operating in L-band (the 1-2 GHz frequency range, there providing typically up to 0.5 Mbit/s data rate) range to operate in Ka-band (the 20-30 GHz frequency range, there capable of providing >100 Mbit/s data rate). While L-band satellite communications is practically unaffected by the atmosphere effects (i.e. attenuation owing to rain, snow etc.), Ka-band satellite communications may exhibit a complete outage in the case of e.g. heavy rain. Thus, there is a demand for integrated antennas capable of simultaneously operating in L- and Ka-band, for use in compact and low-cost, dual-band satellite communication systems, hence providing outage-free operation when combining the two systems.

For dual-band high-performance antenna systems operating in widely spaced frequencies, such as L- and Ka-band, the same antenna cannot easily be used, but two antennas have to be combined. A major challenge in the development of dual-band, high-performance antennas, which shall radiate in the same direction, is to select and integrate the two antennas to have minimum interaction or disturbance onto each other, while yet achieving sufficient performance in both bands. In e.g. a combined L-band/Ka-band antenna system, the Ka-band antenna may (easily) be degraded in gain and sidelobe performance by the presence of the low frequency, L-band antenna. Since the high-frequency Ka-band antenna may often be implemented as e.g. a dual-reflector antenna (comprising a main reflector and a sub-reflector), a key issue is to find a suitable L-band antenna which may be integrated with the Ka-band antenna with minimum disturbance to the Ka-band antenna.

Communication technologies may be seen in: U.S. Pat. No. 4,608,574, Richard C. Johnson and Rickey B. Cotton: “A Backfire Helical Feed”, IEEE Trans Transactions on Antennas and Propagation, Vol. AP-32, No. 10, pp. 1126-1128, October 1984, Hisamatsu Nakano, Junji Yamauchi and Hiroaki Mimaki: “Backfire Radiation from a Monofilar Helix with a Small Ground Plane”, IEEE Transactions on Antennas and Propagation, Vol AP-36, No. 10, pp. 1359-1364, October 1988, H. E. King and J. L. Wong: “240-400 MHz Antenna System for the Fleetsatcom Satellites”, IEEE AP-S, Antennas and Propagation Society International Symposium, 1977, June 21, pp. 349-352, U.S. Pat. No. 7,388,559, JP2226804, JP63194403, U.S. Pat. No. 4,742,359, U.S. Pat. No. 3,184,747, WO9205681, A. Brunner: “Dual polarization coaxial corrugated horn feed with split focus subreflector”, Proc. of 16th ESA Workshop on Dual Polarization Antennas, Jun. 8-9, 1993, ESTEC, Noordwijk, The Netherlands, ESTEC publication no. WPP-051, pp. 205-208, DE4200755, DE9200357, U.S. Pat. No. 5,926,146, U.S. Pat. No. 5,835,057, U.S. Pat. No. 7,038,632, US2003/0234745 and US2008/0120654.

In a first aspect, the invention relates to a dual antenna comprising:
a main reflector,
a sub-reflector,
a helix,
a feed antenna,
   wherein:
the feed antenna is positioned so as to receive radiation reflected by the sub-reflector and/or emit radiation toward the sub-reflector,
the helix is adapted to emit radiation toward and/or receive radiation reflected off the main reflector,
   wherein the sub-reflector is positioned between the main reflector and the helix.

In this context, a dual antenna is an antenna having two or more feed antennas. Naturally, the two or more feed antennas may be of the same or different types and may emit or be configured to emit radiation within the same or different, such as non-overlapping, wavelength intervals. Also, the two or more feed antennas may generally receive or be configured to receive radiation within the same or different, such as non-overlapping, wavelength intervals.

In the present context, the dual antenna has a main reflector and a sub-reflector. The main reflector usually is an element receiving radiation from a radiation emitter, such as a satellite or antenna, or which outputs radiation toward a radiation receiver, such as a satellite or an antenna. In this context, the radiation emitter and/or receiver (antenna or satellite) will not be a part of the present antenna and will usually not be attached thereto.

Usually, the main reflector has the purpose of collecting, collimating, focussing and/or concentrating sufficient radiation and reflecting as much of this radiation as feasible toward another element, such as the sub-reflector, the helix or a satellite/antenna.

The main reflector may be a curved element, such as a parabolic reflector. Alternatively, the main reflector may be a radiation transmissive element, such as a lens, or the main reflector may be a plane element comprising thereon, e.g. a reflecarray performing the collimating/focussing/collecting/concentrating action on the radiation.

Naturally, situations may exist where the main reflector receives radiation from another, even larger element, which larger element then performs the main task of collecting and concentrating radiation.

In this context, a helix is a coiled conductor or conducting element. This element may have one or more conducting elements, such as a monofilar, bifilar, trifilar, quadrifilar coiled element.

The feed antenna may be configured to only be a radiation receiver or only be a radiation transmitter or both.

According to the invention, the feed antenna is positioned so as to receive radiation reflected by the sub-reflector and/or emit radiation toward the sub-reflector. The feed antenna can be, but not limited to, a horn or an open-ended waveguide.

Usually, the main reflector will have a larger cross sectional area, when viewed in a plane perpendicular to a direction between a centre of the main reflector and of the sub-reflector and/or when viewed in a plane perpendicular to a direction between a centre of the main reflector and a radiation emitter/receiver, such as a satellite, toward which the main reflector is aimed. The aim of the main reflector is defined by radiation emitted from the sub-reflector, reflected by the main reflector and impinging on a radiation receiver (e.g. satellite or antenna) or vice versa. Usually, the set-up (positioning and curvatures) of the sub-reflector and the main reflector is so that radiation from a point source at a predetermined position (where the radiation feed antenna usually is positioned) and covering a predetermined area of the sub-reflector will be reflected and impinge on a predetermined area of the main reflector and will then be forwarded as a more or less collimated beam toward the satellite/antenna. Of course, radiation could travel in the opposite direction. This makes no difference.

The main and sub-reflectors preferably form a dual-reflector set-up, such as a so-called Cassegrain antenna set-up, a Gregorian antenna, displaced variants thereof or the like.

The feed antenna and sub-reflector may form a combined unit such as e.g. a splash plate feed, see e.g. U.S. Pat. No. 4,058,812.

The helix is adapted to emit radiation toward and/or receive radiation reflected off the main reflector, so as to be able to use the main reflector as a radiation collector and concentrator in the same manner as the sub-reflector.

When the sub-reflector is positioned between the main reflector and the helix, the helix will not attenuate the radiation travelling between the main and sub-reflectors.

In general, the emission characteristics of the helix depends on a number of factors, such as the number of conductors, the number of windings, the winding pitch, and the diameter of the helix. In addition, the diameter and position of the ground plane as well as the diameter thereof is of relevance. Also, the position of feeding the helix with power or tapping a signal from the helix is of importance.

Preferably, the helix has a central axis directed toward the main reflector, such as a centre of the main reflector.

Usually, an end fire helix will have a ground plane positioned at one end. Therefore, in one embodiment, the antenna further comprises an electrically conducting element positioned between the helix and the main reflector. Preferably, this ground plane or conducting element is positioned so as to ensure that the helix is in an end-fire configuration, and preferably, the helix is in a back-fire configuration. Back-fire configuration describes that the helix then is fed at the end the closest to the main reflector, and that the size of the ground plane is suitable. In Hisamatsu Nakano, Junji Yamauchi and Hiroaki Mimaki: “Backfire Radiation from a Monofilar Helix with a Small Ground Plane”, IEEE Transactions on Antennas and Propagation, Vol AP-36, No. 10, pp. 1359-1364, October 1988, a detailed description is made as to how to generate a back-fire helix.

In a preferred embodiment, the sub-reflector and the ground plane are one and the same element. This not only makes the device lighter and cheaper but also ensures that the helix may be positioned as closely to the sub-reflector as possible so that also the helix may be positioned close to the position at which the main reflector focuses received radiation or from where radiation may be provided on to the main reflector and from which it may subsequently form a nicely collimated beam.

In a preferred embodiment, the antenna further comprises a data provider and a controller, the controller being configured to:
communicate with the feed antenna, the helix and the data provider,
determine a signal quality and/or strength of a signal output of the feed antenna and/or the helix, and
determine, from the determination, one of the feed antenna and the helix and feed a signal from the data provider to the determined one of the feed antenna and the helix.

In this context, the communication may be a receiving of signals from and/or a transmission of signals to the feed antenna and the helix. Usually, the feed antenna and the helix will, when receiving radiation, output a corresponding signal. Naturally, the corresponding signal may correspond to only a part of the received radiation, such as in situations where the feed antenna/helix is configured or able to only receive or convey certain frequencies or frequency intervals. In the same manner, the signal output from a feed antenna/helix may correspond to only certain frequencies or frequency intervals for the same reason.

The controller may be any type of controller, such as an ASIC, an FPGA, a DSP, a software controlled, general processor, a hardwired processor, a combination thereof or the like. The controller may be a single controller or may be a distributed controller formed of different parts communicating with each other, such as over one or more networks.

Naturally, the signal quality may be determined in any desired manner and may be quantified as desired, such as on the basis of:
SNR—Signal to noise ratio >SNR(dB)=10*log 10(P_signal/P_noise)<.
BER—Bit Error Rate is the number of received binary bits that have been altered due to noise and interference, divided by the total number of transferred bits during a studied time interval.
C/No—Carrier to Noise ratio.
Eb/No—Energy per bit relative to noise power spectral density.
PER—Packet Error Rate.
   or other means of determining the data throughput rate and/or QoS of the link.

It is noted that the signal quality may very well differ for the different frequencies, and this determination may be made for each frequency, or the result at one frequency may be used for estimating the signal quality of another frequency.

It is noted that a number of data transmission protocols are adapted to evaluate a bandwidth possible at the frequency in question, and from this, the signal quality may be determined.

When the signal quality has been determined or estimated, the controller may output this or simply use it for the determination.

In some situations, the signal quality of either the signal from one of the helix and the feed antenna may always be lower. One such situation is one where the dual antenna receives radiation from a satellite and where the weather influences the radiation. When the helix and the feed antenna are adapted to receive different wavelengths or wavelength intervals, some wavelengths are inherently more influenced by weather (clouds and precipitation as rain and snow) than others. However, reasons may exist for wishing to use a frequency or frequency interval at which the signal quality is lower, such as when this type of communication, when possible, gives a higher data rate or bandwidth.

Thus, in some situations, it suffices to determine the signal quality of one of the signals from the helix and the feed antenna, such as that which always has the lower quality. If this suffices, that of the helix/feed antenna may then be used; otherwise the other is used. If the signal quality of also the other drops, no communication may be possible using the dual antenna, or it may be desired to direct the dual antenna toward another data transmitter if possible.

In another situation, the dual reflector antenna may be used for one type of communication and the helix for another type, simultaneously. Thus, the dual reflector set-up may be used for download of data where the helix may be used for a much lower bandwidth upload.

The data provider may be any type of data provider, such as a computer, a cell phone, a telephone, a video provider, a multimedia source, a telephone, or the like. The data provider may form part of the controller or may be separate therefrom. The data provider may be a single element or a distributed system of elements communicating with each other and/or the controller.

If the determination results in a communication with a lower bandwidth, the controller or the data provider may select or de-select predetermined types of data in order to ensure that the most important data are transmitted as long as data transmission is possible.

In one embodiment, the helix is configured to emit/receive radiation within a first wavelength interval and the feed antenna is configured to emit/receive radiation within a second wavelength interval.

Preferably, the first wavelength interval comprises wavelengths longer than any wavelength in the second wavelength interval.

Preferably, the first and second frequencies or frequency intervals are so different that the communication at these frequencies has different properties. Usually, such properties are defined at least in part by the frequencies, and it may be desired that the first frequency or interval is below 9 GHz and the second frequency is above 9 GHz, especially if the wireless communication takes place through air/the atmosphere. It is desired that the frequencies are sufficiently different for a difference in properties to exist, whereby it is desired that the second, higher frequency/interval is above 10 GHz. Also, in one embodiment it is desired that the first, lower frequency/interval is below 9 GHz or below 13 GHz.

IEEE has defined Radar-frequency bands, and it is thus preferred that the first frequency is defined in or around the HF, VHF, UHF, L band, S band, C band and X band frequency intervals. Usually, antenna dimensions make the use of frequencies lower than 100 MHz difficult, but this does not render such systems impossible.

Also, it is desired that the second frequency/interval is in or around the X band, Ku band, K band, Ka band, V band, W band or mm band intervals. Usually, the higher the frequency of the carrier, the higher a bandwidth may be transported, but such systems often are more vulnerable to interference etc.

It is noted that the first and/or second frequencies/intervals may each be selected within a pre-defined band, which bands then preferably are different. Also, a frequency often is not merely provided as a single frequency but as a frequency selected within an interval of frequencies. Thus, any frequency described hereafter may be a single frequency or a frequency determined or selected within a frequency interval. Preferably, both selected frequencies as well as frequency intervals are non-overlapping.

In one embodiment, the feed antenna has a waveguide having an axis of symmetry and wherein the sub-reflector and the helix are positioned on the axis of symmetry. In this situation, the dual reflector antenna set-up may be rotational symmetric, and the positioning of the helix also on the symmetry axis minimizes the shadowing of the helix in the radiation received by or emitted by the main reflector while keeping the helix away from the path of the radiation transmitted between the main and sub-reflectors.

The waveguide may be a waveguide adapted to receive radiation and guide it to a detector, or receive radiation from an emitter and guide it toward the sub-reflector.

In another situation, the helix and sub-reflector may be positioned along a line from a centre of the main reflector and the signal source/destination, such as another antenna or a satellite. In that situation, the helix may be positioned in a “shadow” of the sub-reflector and thus not in itself deteriorate the signal to any substantial degree.

In one embodiment, the dual antenna further comprises a cable, such as having two or more conductors, connected to the helix, the cable extending, between the feed antenna and the helix, along the axis of symmetry and/or in a zero field area and thus have a very low detrimental effect on the radiation travelling in the feed antenna.

In general, the present dual antenna may be used for communication with other antennas, such as antennas provided on satellites. The present dual antenna is especially suitable for communicating through the atmosphere, as the dual antenna set-up makes it possible to communicate at different frequencies, which may be required due to atmosphere interference.

The present dual antenna thus may be suitable for use in or on a house, a vehicle, a boat or the like. Alternatively, the antenna may be used in a ground based station usually being a structure fixed in relation to the ground and adapted to communicate with one or more satellites. Such structures may also be called SAS—Satellite Access Station, RAN—Radio Access Node, Earth Station, Ground Station, satellite gateway or LES—Land Earth Station.

In the following, preferred embodiments of the invention will be described with reference to the drawing, wherein:

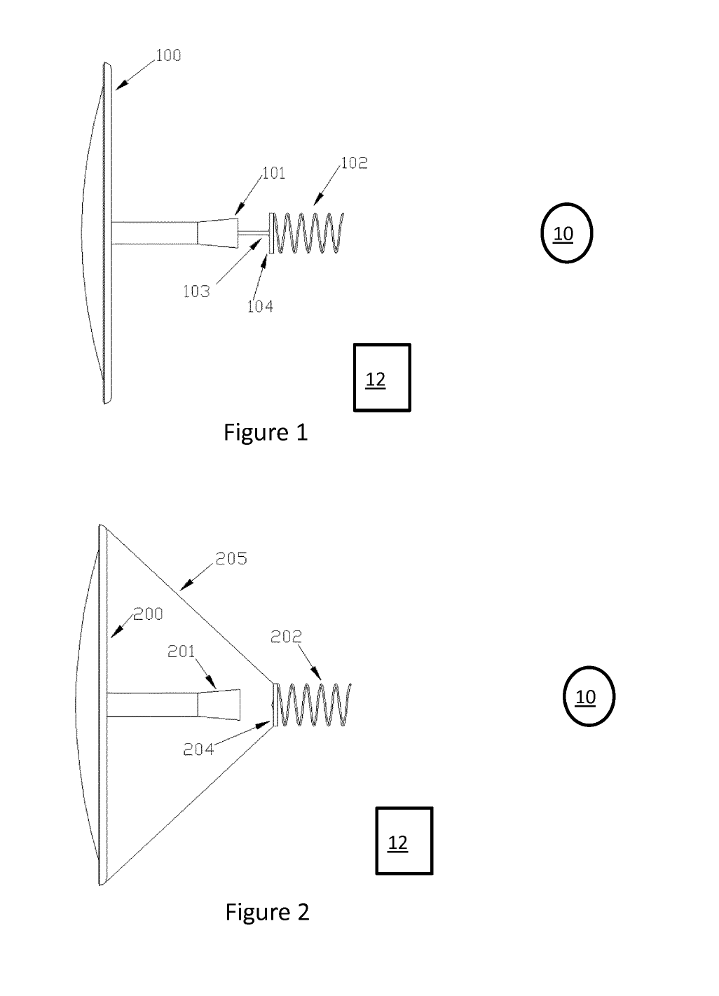

FIG. 1 illustrates a first embodiment according to the invention,

FIG. 2 illustrates a second embodiment according to the invention, and

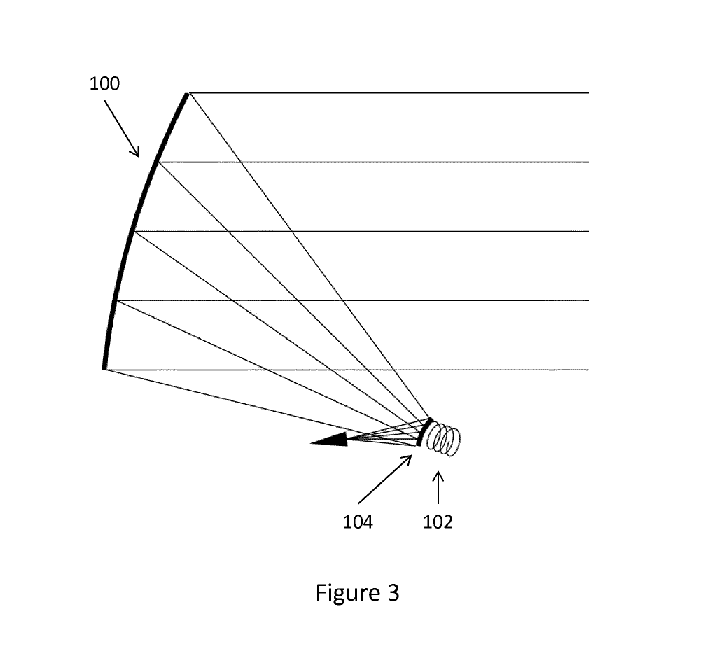

FIG. 3 illustrates a third embodiment according to the invention.

In FIG. 1, a dual-reflector antenna is illustrated having a main reflector 100 and a sub-reflector 104 as well as a feed antenna 101. Radiation travels through the feed antenna 101, impinges on the sub-reflector 104 and reflects of the main reflector 100 to form (or be detected as) a parallel beam along the (horizontal in the drawing) axis of symmetry of the main reflector 100. Preferably, the main reflector 100, feed antenna 101 and sub-reflector 104 are rotational symmetric around this axis.

The sub-reflector 104 is held by a narrow tube 103 extending along the axis of symmetry.

Provided is also a helix 102, which is fed by a cable extending inside the tube 103 and which is configured to also use the main reflector 100 for collecting and focussing radiation onto the helix or directing radiation from the helix 102 into a beam along the axis of symmetry. Alternatively, the tube 103 may constitute a conductor, such as an outer conductor of the cable then being e.g. a semi-rigid coaxial cable.

The helix 102 is fed in a so-called back-fire configuration and thus uses the sub-reflector 104 as the ground plane. Naturally, a separate ground plane may be provided for the helix 102.

Thus, a number of advantages are obtained. Firstly, the main reflector 100 is used by both antennas (dual-reflector setup and the helix), whereby a light weight, compact dual antenna is obtained. Also, the position of the helix 102 is advantageous in that it has only very little impact on the operation of the dual-reflector antenna, as it is positioned in the “shadow” of the sub-reflector 104. In the figure, a satellite 10 is illustrated which transmits information, such as data, at one or more wavelengths toward the antenna, and/or the antenna is emitting data toward the satellite.

Usually, in satellite communication, the weather will determine the signal strength and thus the signal quality at different frequencies. The present dual antenna may thus be used for communicating the same data or with the same antenna, whereby the dual-reflector antenna or a larger frequency is used when the weather or conditions permit and where the helix or a lower frequency is used when required even though this will usually entail communicating with a lower bandwidth.

In one situation, the dual-reflector antenna is adapted to operate in the so-called Ka-band (e.g. the 20-30 GHz frequency range) and thus be capable of providing a bandwidth of more than 100 Mbit/s, whereas the helix may be adapted to operate in the so-called L-band (the 1-2 GHz frequency range), there providing typically up to 0.5 Mbit/s data rate.

The signal to/from the two antennas may be fed to a controller 12 which determines the signal strength or quality to/from the satellite 10 and determines which of the two antennas to use.

The controller 12 thus may be connected to (not illustrated but may be comprised therein for illustrative purposes) a data provider which provides data to be transmitted to the satellite and potentially to another recipient, where the controller determines, based on the signal quality/strength, whether to transmit the data to the satellite using the dual-reflector antenna or the helix. Naturally, the controller may be connected to a typical PC or the like, receiving data from the antenna. The PC may also be the data provider providing the data to be transmitted. The other recipient may be available over the internet, which may be communicated with via the satellite 10. Thus, the data forwarded from the satellite 10 may be received from the internet and may be streamed media information, such as streamed radio, video, movies, TV channels or the like, or may be mails, other data, weather information, home pages or the like. The data forwarded to the other recipient and/or the satellite may be URLs, data, mails, video, images, audio or any other type of data.

The data transmission toward the satellite 10 thus may be controlled to take place using that of the antennas having the best (or at least a minimum) signal quality/strength.

Naturally, the controller may then determine how to reduce that data to be fed to the satellite when the amount of desired data exceeds that possible due to the (weather) conditions, such as by removing leisure data and maintaining important data, allowing primarily predetermined types of data (communication, weather information or the like) and disallowing streaming video/TV/movies, if the available bandwidth does not allow both.

Another manner of operating or using the antenna is to use one of the dual reflector set-up and the helix for one type of data or data in one direction, such as download, while the other of the dual reflector set-up and the helix is used for another type of data or e.g. upload.

In FIG. 2, a slightly different set-up is seen which also has a dual-reflector antenna is illustrated with a main reflector 200 and a sub-reflector 204 as well as a feed antenna 201.

The sub-reflector 204 is held by a number of struts 205 also holding a cable feeding or transporting a signal from a helix 202 again positioned on the symmetry axis of the main reflector. Again, the helix 202 is fed in a so-called back-fire set-up using, again, the sub-reflector 204 as the ground plane.

In all embodiments, the parameters of the helix may be altered, such as the feed position (point of contact between the feeding cable and the helix), as long as the helix is configured to direct a signal toward the main reflector 100 or receive signals therefrom.

Naturally, the dual-reflector antenna and the helix based antenna may be used for transmitting or receiving the same frequency or wavelength or different frequencies/wavelengths.

Again, the satellite 10 and the controller 12 are illustrated.

In FIG. 3, a non-rotationally symmetric set-up is illustrated in which the main reflector 100 reflects the radiation on to the sub-reflector 104, reflecting the radiation toward the feed antenna 101 positioned away from the main reflector 100.

Behind the sub-reflector 104, again, the helix 102 is positioned. The helix 102, in the same manner, is positioned so as to receive radiation reflected by the main reflector 100 and/or emit radiation toward the main reflector 100.

Again, the helix 102 is in a backfire set-up using the sub-reflector 102 as the ground plane.

1. A dual antenna comprising:
a main reflector,
a sub-reflector,
a helix,
a feed antenna,
wherein:
the feed antenna is positioned so as to receive radiation reflected by the sub-reflector and/or emit radiation toward the sub-reflector,
the helix is adapted to emit radiation toward and/or receive radiation reflected off the main reflector,
wherein the sub-reflector is positioned between the main reflector and the helix.

2. An antenna according to claim 1, further comprising an electrically conducting element positioned between the helix and the main reflector.

3. An antenna according to claim 1, wherein the sub-reflector and the conducting element are one and the same element.

4. An antenna according to claim 1, further comprising a data provider and a controller, the controller being configured to:
communicate with the feed antenna, the helix and the data provider,
determine a signal quality and/or strength of a signal output of the feed antenna and/or the helix, and
determine, from the determination, one of the feed antenna and the helix and feed a signal from the data provider to the determined one of the feed antenna and the helix.

5. An antenna according to claim 1, wherein the feed antenna is configured to emit/receive radiation within a first wavelength interval and the helix is configured to emit/receive radiation within a second wavelength interval, the first wavelength interval comprising a wavelength shorter than any wavelength in the second wavelength interval.

6. An antenna according to claim 1, wherein the feed antenna has a wave guide having an axis of symmetry and wherein the sub-reflector and the helix are positioned on the axis of symmetry.

7. An antenna according to claim 6, further comprising a cable connected to the helix, the cable extending, between the feed antenna and the helix, along the axis of symmetry.

8. An antenna according to claim 1, wherein the sub-reflector is positioned as to reflect radiation from the feed antenna toward the main reflector and/or from the main reflector toward the feed antenna.
